(19) United States
(12) Patent Application Publication
(10) Pub. No.: US 2018/0091222 A1
(43) Pub. Date: Mar. 29, 2018

(54) LUMINAIRE

(71) Applicant: PANASONIC INTELLECTUAL PROPERTY MANAGEMENT CO., LTD., Osaka (JP)

(72) Inventor: Takafumi ARAI, Osaka (JP)

(73) Assignee: PANASONIC INTELLECTUAL PROPERTY MANAGEMENT CO., LTD., Osaka (JP)

(21) Appl. No.: 15/712,619

(22) Filed: Sep. 22, 2017

(30) Foreign Application Priority Data
Sep. 29, 2016 (JP) 2016-192316

(51) Int. Cl. H04B 10/116; F21V 5/04; F21S 8/02; F21S 8/06; F21V 21/04; H05B 37/02

(52) U.S. Cl. CPC H04B 10/116; F21V 5/04; F21S 8/026; F21Y 2115/10; F21V 21/04; H05B 37/0272; F21S 8/06

(57) ABSTRACT

A luminaire includes: a main body to which an illumination unit is attached to emit light downward; a projecting portion that projects laterally from the main body when seen from below; and a wireless communication module that receives, by wireless communication, a control signal for controlling operation of the luminaire. The wireless communication module is located lower than a top surface of the projecting portion, and is secured to the projecting portion.

### CROSS REFERENCE TO RELATED APPLICATION

This application claims the benefit of priority of Japanese Patent Application Number 2016-192316 filed on Sep. 29, 2016, the entire content of which is hereby incorporated by reference.

### BACKGROUND

### 1. Technical Field

The present disclosure relates to luminaires having a wireless communication function.

### 2. Description of the Related Art

Luminaires having a wireless communication function are conventionally known. For example, Japanese Unexamined Patent Application Publication No. 2015-177213 (Patent Literature 1) discloses, as a recessed luminaire having a wireless communication function, a ceiling-recessed luminaire provided recessed in a ceiling and emits light downward like a downlight, etc. In the luminaire described in Patent Literature 1, an antenna is provided so as to be exposed from a hole provided in a reflector.

### SUMMARY

From an aesthetic point of view, it is preferable that the antenna included in the luminaire be inconspicuous when the luminaire is in the installed state. As such, in the ceiling-recessed luminaire, it is possible to place a wireless communication module including the antenna on the backside of the ceiling.

The wireless communication module is, for example, connected to a power supply circuit which supplies power to a light source of the luminaire. From the point of view of safety measures, etc., the power supply circuit is typically housed in a metal case. Since metal blocks radio waves, the wireless communication module is placed on an outer surface of the metal case.

When the metal case is a separate body from the main body of the luminaire, the placement position and orientation (placement direction) is up to the constructor. As such, it is difficult to manage how the wireless communication module is placed, and, depending on the placement state, there is a risk that communication performance will deteriorate.

Furthermore, the top of the ceiling-recessed luminaire is covered by an insulating material, etc. Since a metal material such as aluminum foil is often used in the insulating material, there is a risk that the communication performance of the luminaire will deteriorate.

In view of this, the present disclosure provides a luminaire capable of preventing deterioration of communication performance in wireless communication.

A luminaire according to an aspect of the present disclosure is a luminaire having a wireless communication function, and includes: a main body to which a light emitter is attached to emit light forward; a projecting portion that projects laterally from the main body when seen from a front of the luminaire; and a wireless communication unit that receives, by wireless communication, a control signal for controlling operation of the luminaire, wherein the wireless communication unit is located forward of a back surface of the projecting portion, and is secured to the projecting portion.

The luminaire according to the present disclosure is capable of preventing deterioration of communication performance in wireless communication.

### BRIEF DESCRIPTION OF DRAWINGS

The figures depict one or more implementations in accordance the present teaching, by way of examples only, not by way of limitations. In the figures, like reference numerals refer to the same or similar elements.

FIG. 1 is a perspective view of a luminaire according to Embodiment 1;

FIG. 2 is a partial cut-out cross-sectional view of the luminaire according to Embodiment 1;

FIG. 3 is an exploded perspective view of a wireless communication module and resin case of the luminaire according to Embodiment 1;

FIG. 4 is a cross-sectional view schematically illustrating the wireless communication module according to Embodiment 1 secured to a projecting portion;

FIG. 5 is a bottom view schematically illustrating communication ranges of the luminaire according to Embodiment 1;

FIG. 6 is a partial cut-out cross-sectional view of a luminaire according to Embodiment 2; and

FIG. 7 is a cross-sectional view schematically illustrating a wireless communication module according to Embodiment 2 secured to a projecting portion.

### DETAILED DESCRIPTION OF THE EMBODIMENTS

Hereinafter, a luminaire according to exemplary embodiments of the present disclosure will be described in detail with reference to the drawings. It should be noted that each of the subsequently-described embodiments shows a specific example. Therefore, numerical values, shapes, materials, structural components, the arrangement and connection of the structural components, steps, and the sequence of the steps, etc. shown in the following embodiments are mere examples, and are not intended to limit the scope of the present disclosure. Furthermore, among the structural components in the following embodiments, components not recited in any one of the independent claims which indicate the broadest concepts of the present disclosure are described as arbitrary structural components.

Furthermore, the respective figures are schematic diagrams and are not necessarily precise illustrations. Therefore, for example, the scales, etc. in the respective figures are not necessarily uniform. Furthermore, in the respective figures, substantially identical components are assigned the same reference signs, and overlapping description thereof is omitted or simplified.

Hereinafter, in this written description, “front/forward” refers to the direction in which the luminaire emits light; (i.e., light emission direction) and the light extraction direction which light is extracted, and “back/behind” refers to the direction opposite the “front/forward” direction.

Furthermore, in the written description and the drawings, x-axis, y-axis, and z-axis represent three axes in a three-dimensional orthogonal coordinate system. In each embodiment, the z-axis direction is the vertical direction (upward-downward direction), and a direction perpendicular to the z-axis (direction parallel to an xy plane) is a horizontal direction. It should be noted that the positive direction in the z-axis is vertically upward.

### Embodiment 1

[Outline]

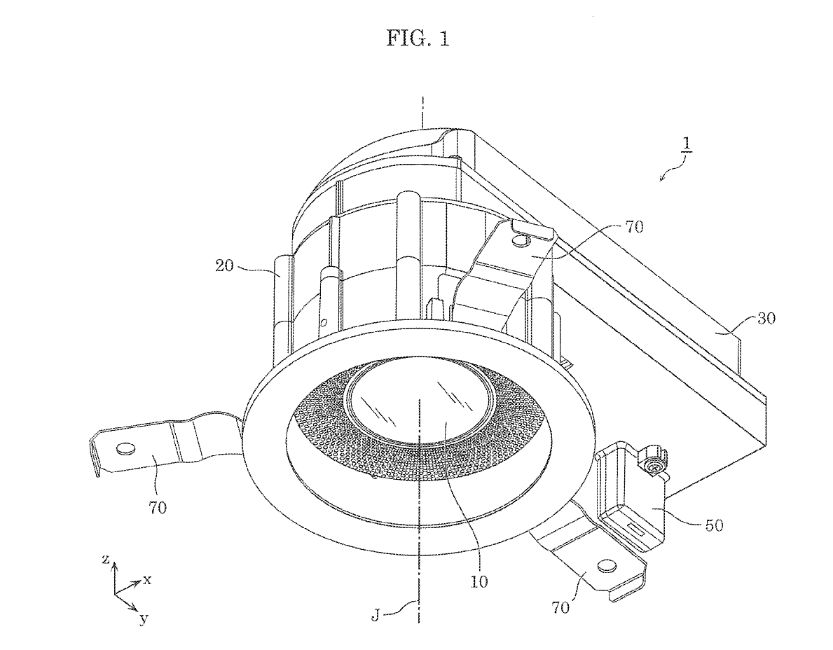

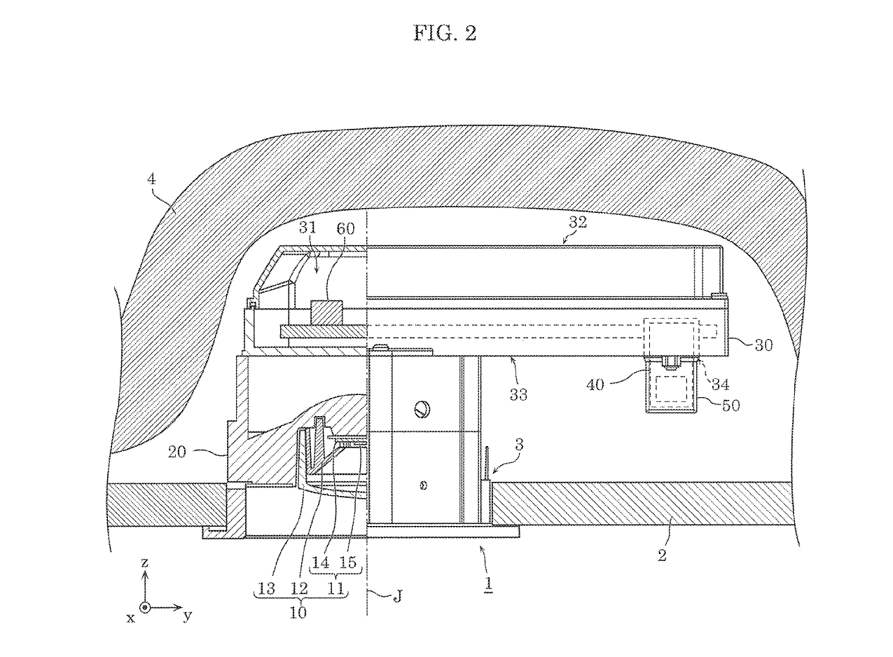

First, the outline of luminaire 1 according to Embodiment 1. will be described with reference to FIG. 1 and FIG. 2.

FIG. 1 is perspective view of luminaire 1 according to this embodiment, FIG. 1 illustrates luminaire 1 when seen from obliquely below.

FIG. 2 is a partial cut-out cross-sectional view of luminaire 1 according to this embodiment. Specifically, FIG. 2 illustrates, in combination, a cross-sectional view (left side) of a cross-section that passes optical axis J of luminaire 1 and a side view (right side) of luminaire 1.

First, FIG. 2 illustrates ceiling material 2 which is an example of a building material to which luminaire 1 is attached. An attachment hole 3 for attaching luminaire 1 is provided in ceiling material 2. The diameter of attachment hole 3 is, for example, 100 mm, but is not limited to such. Insulating material 4 is provided above ceiling material 2 to cover luminaire 1. Insulating material 4 is, for example, an insulating sheet having a metal material, such as aluminum foil, formed on a surface. It should be noted that, in FIG. 2, a cross-section of ceiling material 2, attachment hole 3, and insulating material 4 is illustrated.

Luminaire 1 has optical axis J which coincides with the upward-downward direction (specifically, the vertical direction), and is used in an orientation in which light is emitted downward (vertically downward). For example, luminaire 1 is an example of a recessed luminaire such as a downlight, and is, for example, provided recessed in attachment hole 3 provided in ceiling material 2 of a building so as to emit light downward (toward the floor, etc.).

In this embodiment, luminaire 1 emits light downward, and thus “forward/front” of luminaire 1 is “downward” and is the “light emission direction”. “Backward/behind” of luminaire 1 is “upward” and is the “direction opposite (side opposite) the light emission direction”.

It should be noted that the mode of use of luminaire 1 is not limited to this example. For example, luminaire 1 may be attached to a wall material or a floor material instead of ceiling material 2. In such cases, “forward/front” which is the light emission direction becomes “sideward (horizontal direction)” or “upward (vertically upward)”, respectively. In this manner, “forward/front” of luminaire 1 changes according to the mode of use (attachment orientation) of luminaire 1.

As illustrated in FIG. 1, luminaire 1 includes illumination unit 10, main body 20, projecting portion 30, resin case 50, and attachment springs 70. In addition, as illustrated in FIG. 2, luminaire 1 includes wireless communication module 40 housed inside resin case 50, and power supply circuit 60 housed inside projecting portion 30.

Hereinafter, the respective structural components of luminaire 1 will be described in detail. It should be noted that, although detailed description of all but a few will be omitted, securing components such as locking components or screws for connecting and securing structural components are provided in luminaire 1 as necessary.

[Illumination Unit]

Illumination unit 10 is an example of a light emitter which carries out the illuminating function of luminaire 1. In this embodiment, illumination unit 10 includes light source 11, and emits light vertically downward (i.e., toward the z-axis negative side), as illustrated in FIG, 2. As illustrated in FIG. 2, illumination unit 10 includes light source 11, reflector 12, and light-transmissive cover 13.

Light source 11 is an example of a light source of luminaire 1, and is a light emitter that emits light of a predetermined color (wavelength) such as white. Light source 11 is, for example, secured to a bottom surface on the inside of main body 20 via an adhesive, heat-dissipating component (not illustrated in the figures).

As illustrated in FIG. 2, light source 11 is an LED module that includes light emission substrate 14 and a plurality of LEDs 15. Light source 11 is what is called a chip-on-board (COB) module in which bare chips (LEDs 15) are directly mounted on light emission substrate 14.

For light emission substrate 14, it is possible to use, for example, a ceramic substrate, a resin substrate, or a metal base substrate. The plan view shape of light emission substrate 14 is, for example, rectangular but may be a polygonal shape such as hexagonal or octagonal, or circular, etc. Metal printed wiring (not illustrated in the figures) electrically connecting LEDs 15 is formed on light emission substrate 14.

Each of LEDs 15 is an example of a light-emitting element, and is a semiconductor light-emitting element that emits light according to predetermined power. Each of LEDs 15 is, for example, a bare chip that emits monochromatic visible light, and is specifically a blue light-emitting LED chip that emits blue light when power is supplied. LEDs 15 are arranged in columns or in a matrix on a major surface of light emission substrate 14.

It should be noted that LEDs 15 are collectively sealed by a sealant (not illustrated in the figures). For example, LEDs 15 may be collectively sealed on a per element column basis, or all of LEDs 15 on light emission substrate 14 may be collectively sealed.

For example, the sealant, includes a light-transmissive resin material such as a silicone resin as a main component, and contains a wavelength converting material that converts the wavelength of the light from LEDs 15. The wavelength converting material is, for example, phosphor particles, and is specifically yellow phosphor particles. In this embodiment, light source 11 emits white light through the mixing of the blue light emitted by LEDs 15 and yellow light emitted by the yellow phosphor particles excited by the blue light. It should be noted that the sealant may contain a light-dispersing material (light-scattering particles) such as silica (SiO2), etc.

It should be noted that light source 11 may be a surface mounted device (SMD) module. Specifically, package-type LED elements (SMD LED elements) may be mounted on tight emission substrate 14. A package-type LED element includes, for example, a resin container having a cavity, an LED chip (LED 15) mounted inside the cavity, and a sealant (phosphor-containing resin) which is filled into the cavity.

In this embodiment, light source 11 may include at least one of a dimming function and a toning function. For example, light source 11 emits light of a dimming rate selected from a range from 0% (turned OFF) to 100% (fully turned ON), inclusive. Furthermore, for example, light source 11 emits light of a color temperature selected from a range from 2700 K to 6500 K, inclusive. Dimming rate is an example of a parameter indicating light intensity (irradiance). Color temperature is an example of a parameter indicating the tone of light. The instruction for selecting dimming rate and color temperature is included in a control signal which wireless communication module 40 receives.

It should be noted that light source 11 may independently emit each of red light (R), green light (G), and blue light (B). Light source 11 may control the light outputs for each of RGB (i.e., perform RGB control) according to control signals.

Reflector 12 is a component that controls the distribution of light from light source 11. In this embodiment, reflector 12 reflects the light from light source 11 toward light-transmissive cover 13. Reflector 12 is a substantially tubular body having openings. Optical axis J passes through the approximate center of the openings.

Specifically, as illustrated in FIG. 2, reflector 12 is formed in such a way that its inner diameter increases from the end on the side at which light from light source 11 enters (i.e., the z-axis positive side) to the end on the side at which the light exits. The inner surface of reflector 12 is a reflective surface that reflects the light from light source 11.

Reflector 12 is, for example, secured to main body 20 by using a screw (not illustrated in the figures). For example, by having a portion of reflector 12 press against light emission substrate 14, dropping of light source 11 can be prevented.

Reflector 12 is, for example, formed using a rigid, white resin material such as polybutylene terephthalate (PBT). At this time, a metal reflective film such as aluminum may be provided on the inner face of reflector 12.

Light-transmissive cover 13 is a transmissive component into which light from reflector 12 enters. As illustrated in FIG. 2, light-transmissive cover 13 is disposed to cover the opening of reflector 12 on the light emission side the z-axis negative side).

Light-transmissive cover 13 is made of a light-transmissive material. Light-transmissive cover 13 is formed from a transparent resin material such as acrylic (PMMA) or polycarbonate (PC). Alternatively, light-transmissive cover 13 may be formed from a transparent glass material.

Light-transmissive cover 13 is, for example, supported by reflector 12. Specifically, light-transmissive cover 13 is provided with a recess (not illustrated in the figures) that engages with a claw (not illustrated in the figures) included in reflector 12. Light-transmissive cover 13 is supported by reflector 12 by way of the recess engaging with the claw.

Light-transmissive cover 13 may have a function of controlling the distribution of light entering from reflector 12, and emitting the resulting light. For example, light-transmissive cover 13 may be a Fresnel lens. Furthermore, light-transmissive cover 13 may have a light-dispersing (scattering) structure. For example, light-transmissive cover 13 may be formed using a resin material in which light-dispersing material is dispersed, or irregularities or a dot pattern may be formed on a surface.

[Main Body]

Main body 20 is the main body of luminaire 1. Illumination unit 10 (light emitter) is attached to main body 20 so as to emit light forward, From the point of view of heat dissipation property, etc., main body 20 is formed using a metal material having superior thermal conductivity. For example, main body 20 is made of die cast aluminum but may be formed by pressing.

As illustrated in FIG. 1, main body 20 is a substantially cylindrical tube body substantially centered about optical axis J. As illustrated in FIG. 2, illumination unit 10 is attached to the center portion of main body 20. For example, illumination unit 10 is secured to main body 20 using a screw (not illustrated in the figures).

An annular flange portion is provided at the bottom end (i.e., the end on the light emission side) of main body 20. By sandwiching ceiling material 2 between the flange portion and attachment springs 70, luminaire 1 is attached in attachment hole 3 of ceiling material 2.

[Projecting Portion]

As illustrated in FIG. 2, in this embodiment, projecting portion 30 is a case having internal space 31. There is no particular limitation as to the size and shape of projecting portion 30 as long as projecting portion 30 can be inserted through attachment hole 3 and disposed on the backside of ceiling material 2. For example, projecting portion 30 is a substantially rectangular parallelepiped-shaped case (projecting body) elongated in the projection direction.

When seen from below, projecting portion 30 projects laterally from main body 20. In this embodiment, a portion of projecting portion 30 is located over (i.e., the side opposite the light emission direction) main body 20. Projecting portion 30 projects laterally in a bottom view, so as to cover the upper surface (upper end face) of main body 20.

Projecting portion 30 is, for example, formed using a metal material or a resin material. For example, projecting portion 30 may be made from die-cast aluminum or may be formed by injection molding using a resin material such as PBT.

Projecting portion 30 is, for example, a separate piece (i.e., a different component) from main body 20. Specifically, projecting portion 30 is, for example, secured to main body 20 using a screw (not illustrated in the figures). It should be noted that projecting portion 30 and main body 20 may be configured integrally as a single component). For example, projection portion 30 and main body 20 may be formed integrally by injection molding using a metal material or a resin material.

As illustrated in FIG. 2, projection portion 30 has top surface 32 and bottom surface 33. Top surface 32 is the surface of projection portion 30 on the side opposite the light emission direction, and is the back surface of projecting portion 30. Bottom surface 33 is the surface of projection portion 30 in the light emission direction, and is the front surface of projecting portion 30. Each of top surface 32 and bottom surface 33 are parallel flat surfaces but are not limited to such. At least one of top surface 32 and bottom surface 33 may be a curved surface.

As illustrated in FIG. 2, through hole 34 communicating between internal space 31 and the outside is provided in bottom surface 33. Specifically, through hole 34 is a substantially rectangular slit. The bottom view lengthwise direction of through hole 34 substantially coincides with the projection direction (i.e., the y-axis positive direction) of projecting portion 30.

Through hole 34 is a hole for inserting wireless communication module 40 and resin case 50. Resin case 50, which houses wireless communication module 40, is inserted substantially perpendicularly in through hole 34. The bottom view shape of through hole 34 and the cross-sectional shape (xy cross-section) of resin case 50 substantially coincide.

[Wireless Communication Module (Wireless Communication Unit)]

Wireless communication module 40 is an example of a wireless communication unit which receives, by wireless communication, a control signal for controlling the operation of luminaire 1. The control signal is, for example, a wireless signal transmitted from a portable terminal (operation terminal), such as a remote control or a smart phone, that is operated by a user.

In this embodiment, wireless communication module 40 has a transmitting function aside from a receiving function. For example, wireless communication module 40 transmits the control signal received to another luminaire, etc. Specifically, wireless communication module 40 may relay control signals from the operation terminal to another luminaire. Accordingly, a control signal transmitted from the operation terminal can be received by a luminaire that is far from the operation terminal (i.e., a luminaire that is not located within the communication range of the operation terminal).

Here, wireless communication refers to communication using radio waves (i.e., excluding visible light and infrared light). Wireless communication module 40 performs wireless communication, for example, based on a wireless communication standard such as Wi-Fi (registered trademark), Bluetooth (registered trademark), or ZigBee (registered trademark).

In this embodiment, wireless communication module 40 is electrically connected to power supply circuit 60, and receives an illumination control signal for controlling the turning ON or turning OFF of illumination unit 10. Wireless communication module 40 may receive an illumination control signal for controlling the dimming or toning of illumination unit 10. For example, the illumination control signal includes a turn ON command for turning ON illumination unit 10 or a turn OFF command for turning ON illumination unit 10, or a command for selecting a dimming rate or a color temperature for illumination unit 10, etc.

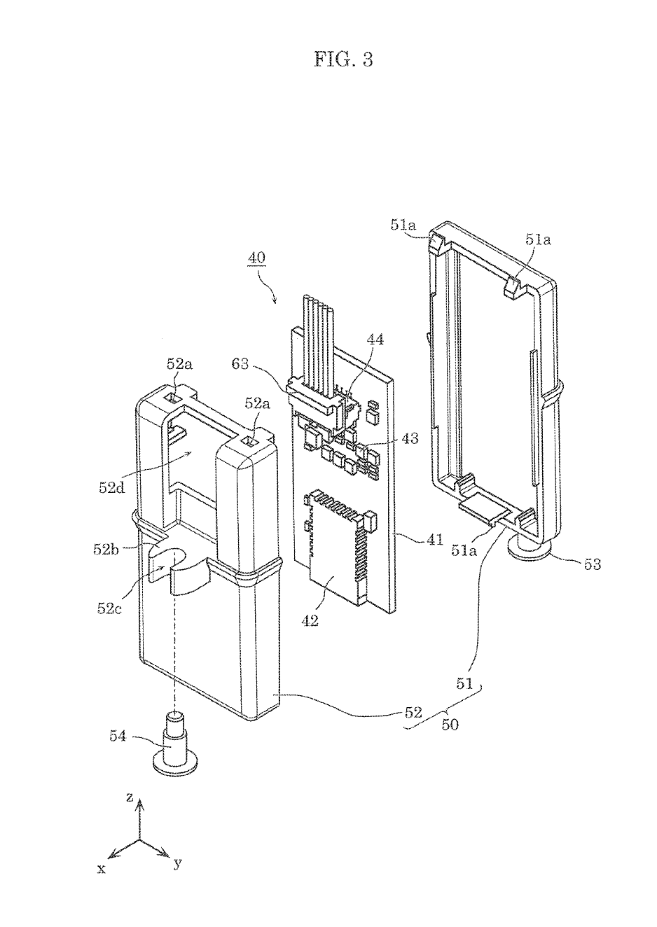

FIG. 3 is an exploded perspective view of wireless communication module 40 and resin case 50 of luminaire 1 according to this embodiment. As illustrated in FIG. 3, wireless communication module 40 includes substrate 41, transceiver 42, controller 43, and connector 44.

Substrate 41 is a printed wiring board, for example, and metal printed wiring (not illustrated in the figures) connecting transceiver-receiver 42 and controller 43 is provided on substrate 41. In this embodiment, substrate 41 is, for example, elongated along the z-axis and the shape of its major surfaces is rectangular.

Transceiver 42 is an example of a receiver that receives a wireless signal. In this embodiment, transceiver 42 is, for example, a chip antenna or a pattern antenna, and transmits and receives wireless signals. Specifically, transceiver 42 receives a control signal transmitted from the operation terminal, etc. Furthermore, transceiver 42 may transmit the received control signal.

Controller 43 is a control circuit that processes the control signal received by transceiver 42. Controller 43 includes, for example, at least one circuit element such as an integrated circuit (IC) chip.

In this embodiment, transceiver 42 is provided at a position that is closer to one end in the lengthwise direction of substrate 41 (i.e., the z-axis negative side). Controller 43 is provided at a position that is closer to the other end in the lengthwise direction of substrate 41 (i.e., the z-axis positive side). In this embodiment, transceiver 42 and controller 43 are mounted on the same major surface of substrate 41 but may be placed on mutually different major surfaces.

Connector 44 is a component for electrically connecting wireless communication module 40 and power supply circuit 60. Connector 44 is, for example, a female connector into which male connector 63 included in power supply circuit 60 is inserted, as illustrated in FIG. 3. Accordingly, wireless communication module 40 and power supply circuit 60 are electrically connected, and a control signal can be transmitted to power supply circuit 60.

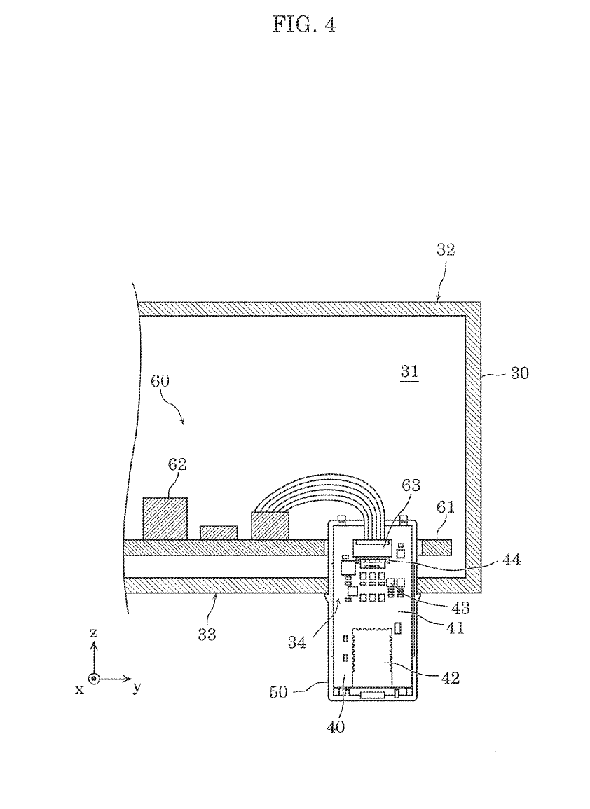

As illustrated in FIG. 4, wireless communication module 40 is secured to projecting portion 30. FIG. 4 is a cross-sectional view schematically illustrating wireless communication module 40 according to this embodiment secured to projecting portion 30. It should be noted that, in FIG. 4, in order to facilitate understanding of the positional relationship between transceiver 42 and controller 43 of wireless communication module 40, wireless communication module 40 is illustrated, not in cross-section, but rather in a view perpendicular to a major surface thereof.

In this embodiment, wireless communication module 40 is secured to bottom surface 33 of projecting portion 30. For example, screw holes (not illustrated in the figures) are provided in the vicinity of through hole 34 of bottom surface 33. By screwing in screws 53 and 54 for securing resin case 50 into the screw holes, resin case 50 is secured to projecting portion 30. Securing resin case 50 to projecting portion 30 secures wireless communication module 40 to projecting portion 30.

As illustrated in FIG. 4, wireless communication module 40 is located lower than top surface 32 of projecting portion 30. In this embodiment, top surface 32 of projecting portion 30 is located in the direction directly above wireless communication module 40. Specifically, at least a portion of wireless communication module 40 is located lower than bottom surface 33 of projecting portion 30.

Specifically, as illustrated in FIG. 4, wireless communication module 40 is secured to projecting portion 30 in such an orientation that the lengthwise direction of substrate 41 coincides with the upward-downward direction (z-axis) and transceiver 42 is on the bottom side of substrate 41. At this time, transceiver 42 is located lower than bottom surface 33 of projecting portion 30. In other words, transceiver 42 is located, not inside internal space 31 of projecting portion 30, but rather outside. Connector 44 and at least a portion of controller 43 are located in internal space 31.

In this embodiment, wireless communication module 40 is secured to projecting portion 30 in such an orientation that the major surfaces of substrate 41 are parallel to the projection direction (i.e., the y-axis positive direction) of projecting portion 30. Specifically, wireless communication module 40 is secured in such an orientation that the thickness direction of substrate 41 is parallel to the x-axis. In other words, the major surfaces of substrate 41 are orthogonal to bottom surface 33 of projecting portion 30.

[Resin Case]

Resin case 50 is a case that internally stores wireless communication module 40. As illustrated in FIG. 3, resin case 50 includes first case 51 and second case 52.

Each of first case 51 and second case 52 is a flat substantially rectangular parallelepiped-shaped (tray-shaped) box having an open major surface. First case 51 and second case 52 are put together by matching up their respective open major surfaces, with wireless communication module 40 being disposed therebetween. First case 51 and second case 52 are secured to each other by engaging claws 51a provided in one of them with recesses 52a provided in the other.

As illustrated in FIG. 3, second case 52 has projection 52b in which cutout-like through hole 52c is provided. Second case 52 is secured to projecting portion 30 by screwing in screw 54 into a corresponding screw hole (not illustrated in the figures) provided in projecting portion 30, via through hole 52c. Although not illustrated in FIG. 3, first case 51 likewise has a projection provided with a cutout-like through hole through which screw 53 is inserted.

Opening 52d is further provided in second case 52 Opening 52d is provided for exposing connector 44 of wireless communication module 40. This enables connector 63 to be inserted into connector 44 in the state where wireless communication module 40 is housed inside resin case 50.

Resin case 50 is, for example, formed using a resin material such as PBT. Specifically, each of first case 51 and second case 52 is formed integrally by injection molding, or the using a resin material.

[Power Supply Circuit]

Power supply circuit 60 is a circuit (lighting circuit) that supplies power for turning ON illumination unit 10 (light source 11). Power supply circuit 60 converts alternating current power supplied from an external power supply such as a power supply system or a storage battery via a cable (not illustrated in the figures), into direct current power, and supplies the direct current power to illumination unit 10.

Power supply circuit 60 specifically controls the turning ON (fully turned ON) and turning OFF of illumination unit 10. Power supply circuit 60 may perform the dimming or toning of illumination unit 10.

For example, power supply circuit 60 regulates the amount of power to supply to illumination unit 10 based on the illumination control signal received by wireless communication module 40. When the illumination control signal includes a tarn ON command for illumination unit 10, power supply circuit 60 supplies power to illumination unit 10 to thereby cause illumination unit 10 to turn ON. When the illumination control signal includes a turn OFF command for illumination unit 10, power supply circuit 60 stops the supply of power to illumination unit 10 to thereby cause illumination 10 to turn OFF. When the illumination control signal includes a command to select a dimming rate or a color temperature for illumination unit 10, power supply circuit 60 performs control to cause illumination unit 10 to emit light corresponding to the dimming rate or color temperature selected according to the command included in the illumination control signal.

As illustrated in FIG. 4, power supply circuit 60 includes, for example, circuit board 61, a plurality of circuit elements 62, and connector 63. Circuit board 61 is, for example, a printed wiring board provided with metal printed wiring that electrically connects circuit elements 62 and connector 63. Circuit elements 62 consist of, for example, a rectifier circuit element, a sense resistor, a fuse element, a resistor, a capacitor, a choke coil, and a diode or a transistor.

Connector 63 is a component for electrically connecting power supply circuit 60 and wireless communication module 40. Connector 63 has one end connected to circuit board 61 and has, in the other end, a male plug terminal that can be inserted into connector 44.

[Attachment Springs]

Attachment springs used to attach luminaire 1 in attachment hole 3 provided in ceiling material 2. Attachment springs 70 are secured to main body 20 so as to extend obliquely upward from the bottom portion of main body 20.

For example, when attaching luminaire 1 in attachment hole 3, first, the leading end of projecting portion 30 is inserted into attachment hole 3, after which main body 20 is inserted into attachment hole 3 in a state where force is applied to attachment springs 70 such that attachment springs 70 are flush against main body 20. Weakening the force applied to attachment springs 70 while inserting main body 20 causes attachment springs 70 to return to their original (downward) positions. At this time, luminaire 1 is secured in attachment hole 3 by taking advantage of the restoring force of attachment springs 70 such that attachment springs 70 and the flange portion of main body 20 clamp onto ceiling material 2.

Attachment springs 70 are formed in the shape of elongated narrow plates by pressing, etc., using a metal material such as iron. As illustrated in FIG. 1, although three attachment springs 70 are included in this embodiment, the number and positions of attachment springs 70 are not limited to such.

[Communication Range of Wireless Communication Module]

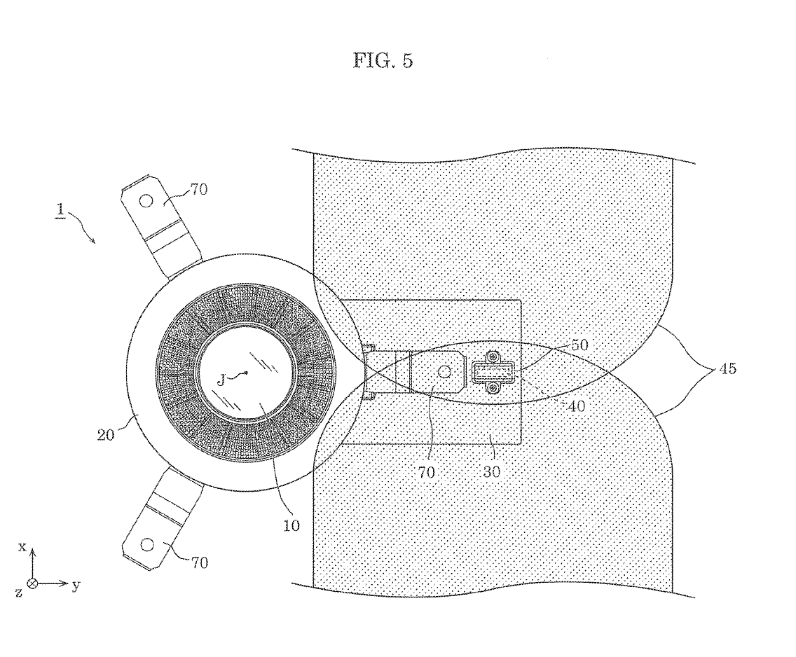

Here, the communication range of wireless communication module 40 will be described with reference to FIG. 5.

FIG. 5 is a bottom view schematically illustrating communication ranges 45 of luminaire 1 according to this embodiment. In FIG. 5, communication ranges 45 are schematically illustrated by shading. It should be noted that communication ranges 45 illustrated in FIG. 5 are schematic depictions of communication ranges when wireless communication module 40 is provided independently (i.e., communication ranges according to design specifications), and are communication ranges which do not take into account the effects of other components such as main body 20.

Wireless communication module 40 has directivity in communication ranges 45 for wireless communication. Communication ranges 45 are the ranges within which transceiver 42 of wireless communication module 40 can transmit and receive wireless signals.

As illustrated in FIG. 5, communication ranges 45 extend from respective major surfaces (yz planes) of substrate 41 in a direction orthogonal to the major surfaces (i.e., the x-axis direction), and are barely formed in a direction parallel to the major surfaces (i.e., the y-axis direction). Specifically, transceiver 42 of wireless communication module 40 can transmit and receive wireless signals in a direction orthogonal to the major surfaces of substrate 41. On the other hand, transceiver 42 is barely able to transmit or receive wireless signals in a direction parallel to the major surfaces of substrate 41. The size (maximum distance) of communication ranges 45 is not particularly limited and is, for example, the size of the space (i.e., the room) in which luminaire 1 is installed, and is several meters to several tens of meters.

In this embodiment, wireless communication module 40 is secured to projecting portion 30 in such an orientation that, when seen from below, overlapping between communication ranges 45 and main body 20 is reduced. Specifically, as illustrated in FIG. 4, wireless communication module 40 is secured to projecting portion 30 in such an orientation that the major surfaces of substrate 41 are parallel to the projection direction (i.e., the y-axis positive direction) of projecting portion 30.

Furthermore, as illustrated in FIG. 4 and FIG. 5, wireless communication module 40 is secured at a position that is closer to the leading end in the projection direction of projecting portion 30. Specifically, wireless communication module 40 is located closer to the leading end than to the center in the projection direction of projecting portion 30. Stated differently, in the y-axis direction, the distance from the leading end of projecting portion 30 to wireless communication module 40 is shorter than the distance from the base of projecting portion 30 (i.e., from main body 20) to wireless communication module 40. For example, wireless communication module 40 may be disposed so as to be in contact with the leading end of projecting portion 30. In this embodiment, wireless communication module 40 is located inward of (i.e., the base-side of) the leading end so as not to project in the projection direction (i.e., the y-axis positive side) from the leading end of projecting portion 30.

### Advantageous Effects, Etc.

As described above, luminaire 1 according the present embodiment is a luminaire having a wireless communication function, and includes: main body 20 to which illumination unit 10 (light emitter) is attached to emit light downward (forward); projecting portion 30 that projects laterally from main body 20 when seen from below; and wireless communication module 40 that receives, by wireless communication, a control signal for controlling operation of luminaire 1. Wireless communication module 40 is located downward of top surface (back surface) 32 of projecting portion 30, and is secured to projecting portion 30. For example, luminaire 1 is a ceiling-recessed luminaire.

Accordingly, as illustrated in FIG. 2, even if insulating material 4 covers luminaire 1, top surface 32 of projecting portion 30 is located over wireless communication module 40, and thus contact between insulating material 4 and wireless communication module 40 can be avoided. In other words, projecting portion 30 functions as a canopy (or cover) that prevents contact between wireless communication module 40 and insulating material 4. Therefore, even if a metal material is used for insulating material 4, deterioration of communication performance in the wireless communication by wireless communication module 40 can be prevented.

Furthermore, wireless communication module 40 is secured to projecting portion 30 which projects from main body 20, and is distanced from illumination unit 10 which is a heat source. Accordingly, it is possible to prevent the heat generated by illumination unit 10 from being transferred to wireless communication module 40, and thus deterioration of communication performance can be prevented.

Furthermore, since the relative positions of wireless communication module 40 and main body 20 are fixed, variations in the attachment position and orientation, etc., of wireless communication module 40 during construction. can be prevented. Therefore, for example, blocking or narrowing of communication ranges 45 of wireless communication module 40 by main body 20, etc., can be prevented, and thus deterioration of communication performance can be prevented.

Furthermore, wireless communication module 40 is located between projecting portion 30 and main body 20 (i.e., the space at the bottom of projecting portion 30), and thus does not easily conic into contact with ceiling material 2, etc., during installation of luminaire 1. Accordingly, since damage or detachment of wireless communication module 40 does not happen easily, deterioration of communication performance can be prevented.

As described above luminaire 1 according to this embodiment is capable of preventing deterioration of communication performance in wireless communication.

Furthermore, for example, wireless communication module 40 (i) includes: substrate 41 which is elongated; and transceiver 42 which is provided closer to one end in a lengthwise direction of substrate 41, and receives the control signal, and (ii) is secured to projecting portion 30 in such an orientation that the lengthwise direction coincides with a upward-downward direction (forward-backward) direction, and transceiver 42 is located at a downward end side of substrate 41.

Ceiling-recessed luminaire 1 having a wireless communication function is typically controlled according to wireless signals from a portable terminal such as a remote control or a smart phone operated by a user present in the room in which luminaire 1 is installed. In other words, luminaire 1 receives wireless signals transmitted from below luminaire 1.

In luminaire 1 according to this embodiment, transceiver 42 is disposed facing down, and thus projecting portion 30 and main body 20 do not become significant obstructions. Accordingly, deterioration of the communication performance of luminaire 1 can be prevented.

Furthermore, for example, transceiver 42 is located lower than bottom surface (front surface) 33 of projecting portion 30.

Accordingly, transceiver 42 is located lower than bottom surface 33 of projecting portion 30, and a space is provided between transceiver 42 and ceiling material 2. Specifically, since a metal component such as main body 20 is not provided under transceiver 42, deterioration of the communication performance of transceiver 42 can be prevented.

Furthermore, for example, wireless communication module 40 is secured to projecting portion 30 in such an orientation that the major surfaces of substrate 41 are parallel to the projection direction of projecting portion 30.

Accordingly, as illustrated in FIG. 5, wireless communication module 40 has communication ranges 45 in which receiver sensitivity intensifies in a direction orthogonal to the major surfaces of substrate 41 and weakens in a direction parallel to the major surfaces of substrate 41. Therefore, since main body 20 is not located in the direction in which receiver intensity is strong, deterioration of the communication performance of luminaire 1 can be prevented.

Furthermore, for example, wireless communication module 40 is secured at a position closer to a leading end in the projection direction of projecting portion 30.

Accordingly, since wireless communication module 40 can be further distanced from main body 20, communication obstruction by main body 20 can be reduced. Accordingly, deterioration of the communication performance of luminaire 1 can be prevented.

Furthermore, for example, wireless communication module 40 has directivity in communication ranges 45 of the wireless communication, and is secured in such an orientation that overlapping between communication ranges 45 and main body 20 is reduced when seen from below.

Accordingly, since overlapping between main body and communication ranges 45 can be reduced, deterioration of communication performance caused by main body 20 can be prevented.

Furthermore, for example, luminaire 1 further includes power supply circuit 60 which is housed inside projecting portion 30, and supplies power for turning ON illumination unit 10, and wireless communication module 40 is electrically connected to power supply circuit 60, and receives the control signal for controlling turning ON and turning OFF of illumination unit 10.

Accordingly, since power supply circuit 60 is housed inside projecting portion 30, luminaire 1 can be made smaller compared to when power supply circuit 60 is housed in a case that is separate from main body 20. Furthermore, since wireless communication module 40 can be directly connected to power supply circuit 60, the number of components can be reduced.

### Embodiment 2

Next, Embodiment 2 will be described.

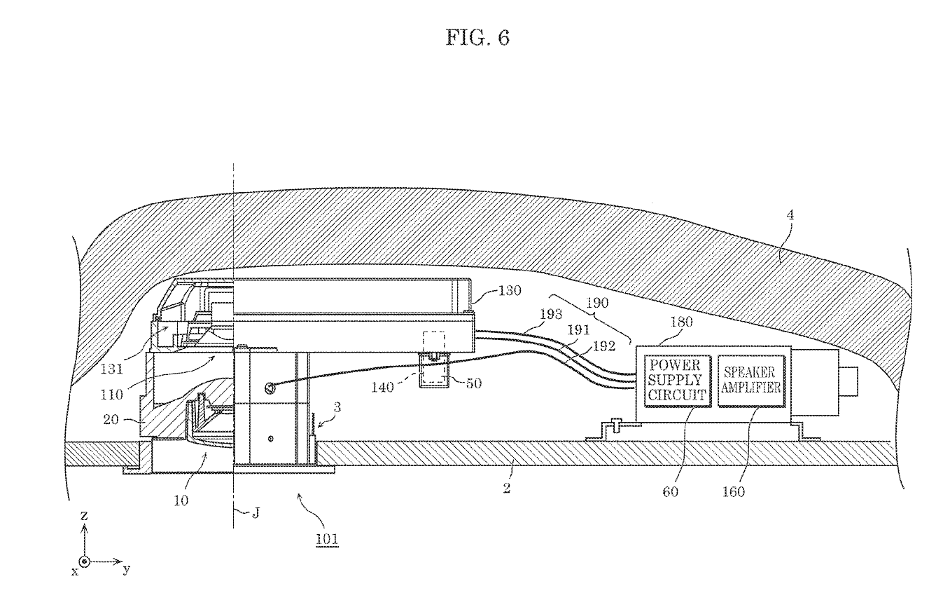

FIG. 6 is a partial cut-out cross-sectional view of luminaire 101 according to this embodiment. Specifically, FIG. 6 illustrates, in combination, a cross-sectional view (left side) of a cross-section that passes optical axis J of luminaire 101 and a side view (right side) of luminaire 101.

As illustrated in FIG. 6, luminaire 101 is different compared to luminaire 1 according to Embodiment 1 in terms of further including speaker 110, speaker amplifier 160, case 180, and wiring 190, and in including projecting portion 130 and wireless communication module 140 in place of projecting portion 30 and wireless communication module 40. Hereinafter, description will be carried out focusing on the points of difference with Embodiment 1, and description of common points may be omitted or simplified.

[Speaker]

Speaker 110 is a component that carries out the acoustic function of luminaire 101. In this embodiment, speaker 110 emits various sounds such as music, a voice, an alarm, etc. The sound emission direction of speaker 110 is the z-axis negative side, and substantially coincides with the light emission direction of illumination unit 10 (i.e., downward).

In this embodiment, speaker 110 is disposed on the opposite side of the light emission direction (i.e., the z-axis positive side) of illumination unit 10, that is, behind illumination unit 10. The sound emitted by speaker 110 is emitted downward via a hole (not illustrated in the figures) provided around illumination unit 10 inside main body 20.

Speaker 110 is, for example, a cone speaker, and includes a diaphragm (cone paper), a voice coil, a damper, a magnetic circuit (yoke with U-shaped cross-section, magnet, and plate), etc. Speaker 110 has a terminal to which third cable 193 of wiring 190 is connected, and is electrically connected to speaker amplifier 160.

For example, the magnetic circuit causes the voice coil to vibrate, based on an audio signal transmitted from speaker amplifier 160 via third cable 193. The damper transmits the vibration of the voice coil to the diaphragm, and thereby speaker 110 emits sound downward.

[Projecting Portion]

Projecting portion 130 is different compared to projecting portion 30 according to Embodiment 1 in terms of internally housing speaker 110. Specifically, projecting portion 130 is a case having internal space 131. Internal space 131 corresponds to the rearward space of speaker 110. Projecting portion 130 is an enclosure which covers the rearward space of speaker 110, and contributes to the improvement of sound quality of speaker 110.

By enlarging internal space 131, the sound quality of speaker 110 can be improved. For this reason, power supply circuit 60 is not housed in internal space 131.

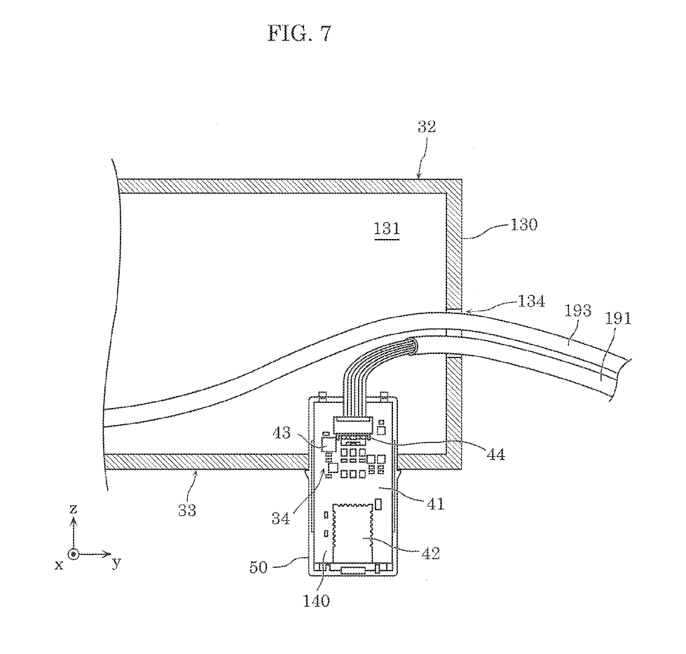

In this embodiment, as illustrated in FIG. 7, wireless communication module 140 housed in resin case 50 is secured to the bottom surface of projecting portion 130, in the same manner as in Embodiment 1. FIG. 7 is a cross-sectional view schematically illustrating wireless communication module 140 according to this embodiment secured to projecting portion 130. It should be noted that, as in FIG. 4, in FIG. 7, in order to facilitate understanding of the positional relationship between transceiver 42 and controller 43 of wireless communication module 140, wireless communication module 140 is illustrated, not in cross-section, but rather in a view perpendicular to a major surface thereof.

As illustrated in FIG. 7, insertion hole 134 for the insertion of first cable 191 and third cable 193 of wiring 190 is provided in projecting portion 130. Furthermore, as in Embodiment 1, projecting portion 130 has top surface 32 and bottom surface 33, and through hole 34 for the insertion of wireless communication module 140 and resin case 50 is provided in bottom surface 33.

[Wireless Communication Module]

Wireless communication module 140 is different compared to wireless communication module 40 according to Embodiment 1 in terms of further receiving audio control signals for controlling the sound emission and muting of speaker 110. For example, the audio control signal includes a sound emission command for causing speaker 110 to output sound and a muting command for stopping the sound output of speaker 110. Furthermore, the audio control signal includes an audio signal (audio data) to be output by speaker 110.

In this embodiment, wireless communication module 140 is connected to power supply circuit 60 and speaker amplifier 160 via first cable 191. For example, as illustrated in FIG. 7, first cable 191 is connected to connector 44 of wireless communication module 140. Wireless communication module 140 outputs a received. illumination control signal to power supply circuit 60 and outputs a received audio control signal to speaker amplifier 160, via first cable 191.

The configuration, communication range, attachment position, etc., of wireless communication module 140 are the same as those of wireless communication module 40 according to Embodiment 1.

[Speaker Amplifier]

Speaker amplifier 160 is an amplifier circuit that amplifies an audio signal and outputs the result to speaker 110. Although not illustrated in the figures, speaker amplifier 160 includes a circuit board, and circuit elements mounted on the circuit board. It should be noted that speaker amplifier 160 and power supply circuit 60 may share a single circuit board.

First cable 191 and third cable 193 are connected to speaker amplifier 160. The audio control signal received by wireless communication module 140 is transmitted to speaker amplifier 160, via first cable 191. Speaker amplifier 160 supplies the audio signal (audio data) included in the audio control signal to speaker 110, via third cable 193.

[Case]

Case 180 is a case for housing power supply circuit 60, and is provided

separately from main body 20. In this embodiment, speaker amplifier 160 is further housed inside case 180. An insertion hole (not illustrated in the figures) for the insertion of first cable 191, second cable 192, and third cable 193 of wiring 190, for example, is provided in case 180.

Case 180 is, for example, formed, using a metal material, for protecting power supply circuit 60, etc. For example, case 180 is formed by pressing a sheet of aluminum, etc., but is not limited to such.

As illustrated in FIG. 6, case 180 is, for example, placed on the back surface (top surface) of ceiling 2. There is no particular limitation as to the size and shape of case 180 as long as case 180 can be inserted through. attachment hole 3 and disposed on the backside of ceiling material 2. For example, case 180 may be of the same size as projecting portion 130.

[Wiring]

Wiring 190 connects main body 20 and projecting portion 130 with case 180. Specifically, first cable 191, second cable 192, and third cable 193 are included in wiring 190.

First cable 191 connects wireless communication module 140 with power supply circuit 60 and speaker amplifier 160. First cable 191 transmits a control signal received by wireless communication module 140 to power supply circuit 60 and speaker amplifier 160. As illustrated in FIG. 7, first cable 191 is inserted into insertion hole 134 provided in projecting portion 130, and is connected to connector 44 of wireless communication module 140.

Second cable 192 connects power supply circuit 60 and illumination unit 10. Second cable 192 supplies power from power supply circuit 60 to illumination unit 10. Second cable 192 is inserted into an insertion hole (not illustrated in the figures) provided in a lateral surface of main body 20, and is connected to illumination unit 10.

Third cable 193 connects speaker amplifier 160 and speaker 110. Third cable 193 supplies audio signals from speaker amplifier 160 to speaker 110. Third cable 193 is inserted into insertion hole 134 provided in projecting portion 130, and is connected to a terminal of speaker 110.

It should be noted that a through hole may be provided in projecting portion 130 at a position near speaker 110, and third cable 193 may be inserted into this through hole. Accordingly, the length of third cable 193 located inside internal space 131 of projecting portion 130 can be shortened, and thus internal space 131 can be enlarged. Accordingly, the quality of sound emitted by speaker 110 can be improved.

### Advantageous Effects, Etc.

As described above, luminaire 101 according to this embodiment further includes speaker 110, and wireless communication module 140 receives control signals for controlling the sound emission and muting of speaker 110.

Accordingly, since speaker 110 is housed inside projecting portion 130, luminaire 101 can be made smaller compared to when speaker 110 is housed in a case that is separate from main body 20. Furthermore, aside from the illumination function of luminaire 101, the acoustic function can also be wirelessly controlled.

Furthermore, for example, luminaire 101 further includes: power supply circuit 60 that supplies power for turning ON illumination unit 10; case 180 provided away from main body 20 and housing power supply circuit 60; and wiring 190 for transmitting a control signal received by wireless communication module 140 to power supply circuit 60, and supplying the power from power supply circuit 60 to illumination unit 10.

Accordingly, since power supply circuit 60 is housed in case 180 which is different from main body 20 and projecting portion 130, internal space 131 of projecting portion 130, for example, can be enlarged. When internal space 131 is used as the rearward space of speaker 110, the rearward space can be enlarged, and thus the sound quality of speaker 110 can be improved.

### Others

Although luminaires according to one or more aspects of the present invention have been described based on exemplary embodiments up to this point, the present invention is not limited to the foregoing embodiments.

For example, although in the foregoing embodiments an example is given in which a portion of wireless communication module 40 or 140 is located inside projecting portion 30 or 130, the present invention is not limited to such. Substantially the entirety of wireless communication module 40 or 140 is located below projecting portion 30 or 130. For example, wireless communication module 40 or 140 may be secured to projecting portion 30 or 130 in such an orientation that both transceiver 42 and controller 43 are located lower than bottom surface 33 of projecting portion 30 or 130.

For example, in Embodiment 2, the entirety of wireless communication module 140 may be secured to bottom surface 33 so as to be located lower than bottom surface 33 of projecting portion 130. In this case, the connection between first cable 191 and wireless communication module 140 is performed outside of projecting portion 130, insertion hole 134 need not be provided in projecting portion 130. Accordingly, internal space 131 of projecting portion 130 can be further enlarged, and the quality of the sound emitted by speaker 110 can be further improved.

Furthermore, for example, although in the foregoing embodiments an example is given in which projecting portion 30 or 130 is formed using a metal material, projecting portion 30 or 130 may be formed using a resin material. In this case, since projecting portion 30 or 130 transmits wireless signals (radio waves), wireless communication module 40 or 140 may be housed inside projecting portion 30 or 130. In other words, wireless communication module 40 or 140 may be located between top surface 32 and bottom surface 33, instead of being located lower than bottom surface 33 of projecting portion 30 or 130.

Furthermore, for example, although in the foregoing embodiments an example is given in which power supply circuit 60 or speaker 110 is housed inside projecting portion 30 or 130, the present invention is not limited to such. Specifically, projecting portion 30 or 130 need not have internal space 31 or 131.

For example, projecting portion 30 or 130 may be a board-shaped or rod-shaped projecting portion projecting sideward from main body 20. Wireless communication module 40 or 140 is, for example, secured to the board-shaped or rod-shaped projecting portion so as to be located lower than the top surface of the projecting portion. In this manner, projecting portion 30 or 130 may be provided just for securing wireless communication module 40 or 140.

In this case, for example, power supply circuit 60 may be housed in a separate case, as in Embodiment 2. Speaker 110 may be housed inside main body 20 or in a case other than main body 20.

Furthermore, for example, although wireless communication module 40 or 140 is secured to projecting portion 30 or 130 by securing resin case 50 which houses wireless communication module 40 or 140 to projecting portion 30 or 130, the present invention is not limited to such. Luminaire 1 or 101 need not include resin case 50, and wireless communication module 40 or 140 may be directly secured to projecting portion 30 or 130. For example, wireless communication module 40 or 140 may be secured to projecting portion 30 or 130 by using an adhesive, etc.

Furthermore, for example, although in the foregoing embodiments an example is given in which substrate 41 of wireless communication module 40 or 140 is elongated, the present invention is not limited to such. For example, the shape of the major surfaces of substrate 41 may be square or circular. Transceiver 42 and controller 43 may be placed side-by-side on a major surface of square-shaped substrate 41. In this case, wireless communication module 40 or 140 may, for example, be secured to projecting portion 30 or 130 in such an orientation that transceiver 42 is located downward (i.e., on the light emission side) of controller 43.

Furthermore, for example, although in the foregoing embodiment an example is given in which wireless communication module 40 or 140 has transmitting and receiving functions, the present invention is not limited to such. For example, wireless communication module 40 or 140 may have only a signal receiving function, and need not have a transmitting function. Specifically, wireless communication module 40 or 140 may include, in place of transceiver 42, a receiver that performs only the reception of wireless signals.

Furthermore, for example, although in the foregoing embodiments example is given in which illumination unit 10 includes LEDs, the present invention is not limited to such. Illumination unit 10 may include organic electroluminescent (EL) elements or laser elements, etc. Furthermore, luminaire 1 or 101 may include, as illumination unit 10, a detachable bulb-type lamp.

Furthermore, for example, although in the foregoing embodiments an example is given in which luminaire 1 or 101 is a ceiling-recessed luminaire such as a downlight. For example, luminaire 1 or 101 may be a ceiling light, a spot light, a floor light, etc.

Forms obtained by various modifications to the embodiments that can be conceived by a person of skill in the art as well as forms realized by arbitrarily combining structural components and functions in the embodiments which are within the scope of the essence of the present invention are included in the present invention.

What is claimed is:

1. A luminaire having a wireless communication function, the luminaire comprising:
a main body to which a light emitter is attached to emit light forward;
a projecting portion that projects laterally from the main body when seen from a front of the luminaire; and
wireless communication unit that receives, by wireless communication, a control signal for controlling operation of the luminaire, wherein
the wireless communication unit is located forward of a back surface of the projecting portion, and is secured to the projecting portion.

2. The luminaire according to claim 1, wherein
the wireless communication unit
(i) includes:
a substrate which is elongated; and
a receiver which is provided closer to one end in a lengthwise direction of the substrate, and receives the control signal, and
(ii) is secured to the projecting portion in such an orientation that the lengthwise direction coincides with a forward-backward direction, and the receiver is located at a forward end side of the substrate.

3. The luminaire, according to claim 2, wherein
the receiver is located forward of a front surface of the projecting portion.

4. The luminaire according to claim 2, wherein
the wireless communication unit is secured to the projecting portion in such an orientation that major surfaces of the substrate are parallel to a projection direction of the projecting portion.

5. The luminaire according to claim 2, wherein
the wireless communication unit is secured at a position closer to a leading end in a projection direction of the projecting portion.

6. The luminaire according to claim 1, wherein
the wireless communication unit has directivity in a communication range of the wireless communication, and is secured in such an orientation that overlapping between the communication range and the main body is reduced when seen from the front of the luminaire.

7. The luminaire according to claim 1, further comprising:
a speaker, wherein
the wireless communication unit receives the control signal for controlling sound emission or muting of the speaker.

8. The luminaire according to claim 1, further comprising:
a power supply circuit, which is housed inside the projecting portion, and supplies power for turning ON the light emitter, wherein
the wireless communication unit is electrically connected to the power supply circuit, and receives the control signal for controlling turning ON and turning OFF of the light emitter.

9. The luminaire according to claim 1, further comprising:
a power supply circuit that supplies power for turning ON the light emitter;
a case provided away from the main body and housing the power supply circuit; and
wiring for transmitting a control signal received by the wireless communication unit to the power supply circuit, and supplying the power from the power supply circuit to the light emitter.

10. The luminaire according to claim 1, wherein
the luminaire is a ceiling-recessed luminaire.
